(19) United States
(12) Patent Application Publication
(10) Pub. No.: US 2009/0103074 A1
(43) Pub. Date: Apr. 23, 2009

(54) Methods for Performing Quality Control of Process to Treat a Surface

(75) Inventors: Jerome J. Cuomo, Cary, NC (US); Vinay G. Sakhrani, Raleigh, NC (US)

Correspondence Address: DAVID P. HENDRICKS;LAW OFFICE OF DAVID P. HENDRICKS, PO BOX 37127, RALEIGH, NC, 27627, US

(73) Assignee: TRIBOFILM RESEARCH, INC., Raleigh, NC (US)

(21) Appl. No.: 11/873,943

(22) Filed: Oct. 17, 2007

(51) Int. Cl. G01J 3/00; G01J 3/443

(52) U.S. Cl. 356/51; 356/300; 356/311

(57) ABSTRACT

The present application is directed to methods for performing quality control analysis of a process to treat a surface of a workpiece. A sensor is placed in proximity to the surface, and a controller analyzes data obtained by analyzing a signal from the sensor. The controller may determine whether the process started properly, the presence of a lubricant on the surface, and the amount of the lubricant.

### BACKGROUND

The present application is directed to methods for performing quality control analyses, and more specifically to performing quality control analyses of a process to plasma treat a lubricant coated surface.

It is often beneficial to apply a coating to medical devices, such as syringes, vials, needles, and the like, to impart or enhance certain properties. For example, syringe barrels may be coated to enhance the lubricous properties of the barrel to allow a plunger to move smoothly within the barrel. In a variety of situations, the coating may require treatment after application in order to obtain the desired property. One example of treating a coating includes exposing the coating to an energy source, such as an ionizing gas plasma.

Syringe manufacturing lines may produce as many as 300 syringes per minute. Because each syringe has the potential to be used in a life threatening situation, quality control of the manufacturing process is critical. Crucial patient treatment time may be lost when a medical device fails in the field. Additionally, failure of the device may lead to inadequate delivery of treatment, which may place a patient's life at risk.

Current quality control methods may involve performing an analysis on a statistical sample of a batch of the medical devices. If the statistical sample passes, then the entire batch passes. However, such methods may overlook intermittent failures in the process and allow defective devices to pass inspection.

### SUMMARY

The present application is directed to methods for performing quality control analysis of a process to treat a surface of a workpiece. A sensor is placed in proximity to the surface, and a controller analyzes data obtained by analyzing a signal from the sensor. The controller may determine whether the process started properly, the presence of a lubricant on the surface, and the amount of the lubricant.

### BRIEF DESCRIPTION OF THE DRAWINGS

FIG. 1 is a schematic diagram of devices used to treat a lubricant coated surface and perform quality control methods according to one embodiment.

FIG. 2 is a graph of the intensity of an emitted spectrum for a wavelength range according to one embodiment.

FIG. 3 is a close-up of an emitted spectrum illustrating a peak at a certain wavelength according to one embodiment.

FIG. 4 is a close-up of an emitted spectrum illustrating a peak at a certain wavelength according to one embodiment.

FIG. 5 is process flow diagram of a method according to one embodiment.

### DETAILED DESCRIPTION

The present application is directed to methods for performing quality control analyses of a process to treat a lubricant coated surface of a workpiece. The workpiece including the lubricant coated surface is positioned in a treatment apparatus. A sensor is placed in proximity to the workpiece. As the process is started, an analyzing device analyzes a signal from the sensor and outputs data. A controller analyzes the data to first determine whether the process started properly. The controller then further analyzes the data to determine whether lubricant is present on the workpiece, as well as the amount of the lubricant.

One embodiment of the present application may be used with a treatment process utilizing an ionizing gas plasma to treat the lubricant on the surface of the workpiece. An exemplary process is presented in U.S. Patent Publication No. 2004-0231926 A1 filed on Mar. 2, 2004, which is herein incorporated by reference in its entirety. Glow discharge optical emission spectroscopy (GD-OES) may be used to analyze the emission spectrum of the plasma used to treat the lubricant coated surface. As the plasma is initially generated, atoms of the lubricant may be promoted to higher energy levels. As the atoms decay back to a lower energy level, electromagnetic radiation (i.e., light) is emitted. A characteristic emission spectrum is generated for each chemical species present in the plasma, or that is excited by the plasma. The characteristic emission spectrum may include peaks at specific wavelengths. These peaks may be detected by a device such as a spectrometer. The wavelength of the peaks, as well as the intensity of the peaks may be used to perform a quality control analysis of the treatment process.

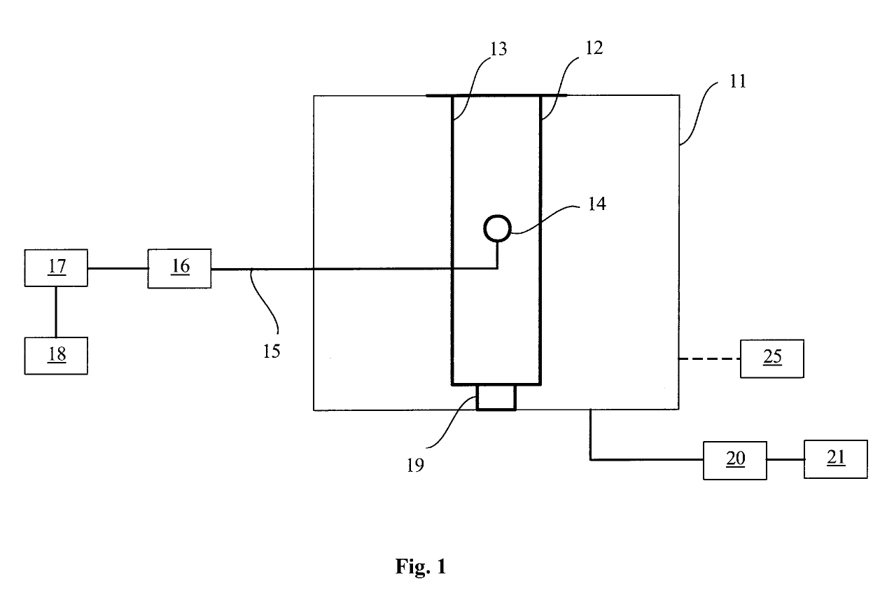

FIG. 1 illustrates a schematic diagram of one embodiment of devices used to treat the workpiece and perform the quality control method. A treatment device may comprise an outer electrode 11 adapted to receive the workpiece 12. The workpiece may include a lubricant coated surface 13. An inner electrode (not shown) may be inserted into the workpiece 12. A power supply 25 is operatively connected to the outer electrode 11 and the inner electrode. A carrier gas which may also include a reactive gas may be introduced into the workpiece 12 through a gas distribution manifold 19 and flows adjacent to the lubricant coated surface 13. A first controller 20 may oversee operation of the treatment device and may include memory 21. Details of an exemplary treatment device are presented in U.S. Patent Publication No. 2007-0235427 A1 filed on Apr. 3, 2007, which is herein incorporated by reference in its entirety.

In one embodiment, a quality control device comprises a sensor 14, an analyzing device 16, a connector 15 between the sensor 14 and the analyzing device 16, a second controller 17, and memory 18. The sensor 14 may be placed in proximity to the workpiece. The sensor 14 is operative to sense the spectrum emitted by the plasma and communicate with the analyzing device 16 by communicating a signal through the connector 15. The second controller 17 is operatively connected to the analyzing device 16 and receives a signal from the analyzing device 16. The second controller 17 may include memory 18 for storing operating parameters and instructions, or for storing data.

The sensor 14 may include a device capable of sensing the emitted spectrum and converting the emitted spectrum to an electronic signal. The electronic signal may then be transmitted by the connector 15 to the analyzing device 16. In one embodiment, the connector 15 is a fiber optic cable and no sensor 14 is used. The fiber optic cable may transmit the emitted spectrum to the analyzing device 16 with or without the sensor 14.

In one embodiment, the analyzing device 16 is a spectrometer. The spectrometer receives the emitted spectrum transmitted by the connector 15. As is well known in the art, the spectrometer measures the intensity of the emitted spectrum across a predetermined wavelength range. The spectrometer outputs data either directly to a user or to the second controller 17. The data may then be used to perform quality control analyses of the treatment process as detailed below.

Prior to initiating the treatment process (i.e., before the plasma is generated), a first reading may be taken by the analyzing device 16 of a background spectrum sensed by the sensor 14. In one embodiment, the analyzing device 16 determines the intensity of the background spectrum across a predetermined range of wavelengths. In another embodiment, the analyzing device 16 determines the intensity of the background spectrum at one or more predetermined wavelengths. The background spectrum intensity may be taken one time, or multiple times. Each background spectrum intensity value may be stored in memory 18.

The treatment process may be initiated by the first controller 20 sending a signal to energize the power supply 25. At this point, the power supply 25 may generate an electric field between the outer electrode 11 and the inner electrode, thereby igniting the plasma in the gas. If the plasma ignites properly, then the emission spectrum may vary from that detected during the background reading. Once the power supply 25 is energized, the second controller 17 obtains a second reading of the emitted spectrum from the analyzing device 16. The intensity of the emitted spectrum is then determined based on the second reading. The intensity is then compared to the background intensity value. If the intensity after energizing the power supply 25 exceeds the background intensity by more than a predetermined amount, then the second controller 17 determines that the plasma has ignited, and the treatment process is allowed to continue.

This step of the quality control method detects whether the plasma has initially ignited. Factors that may influence plasma ignition include electrical connection between the power supply 25 and the outer electrode 11 and the inner electrode, proper grounding of one of the electrodes, and the presence of the gas.

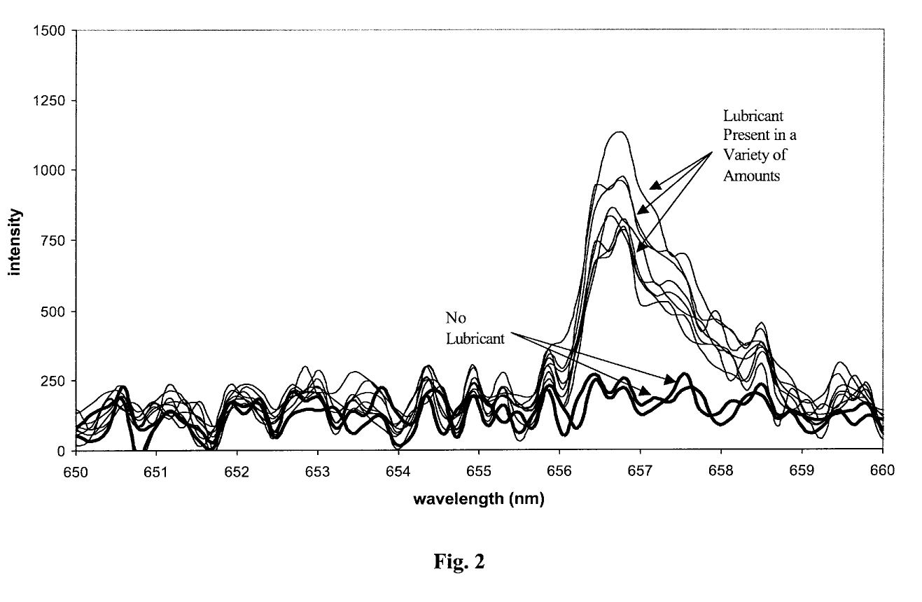

FIG. 2 illustrates an emission spectrum used to determine the presence of the lubricant on the surface of the workpiece for one embodiment. Each lubricant used in the treatment process may generate a characteristic emission spectrum. Each of these spectra may include peaks of intensity at known wavelengths. The peaks may occur at one wavelength or more than one wavelength. In the embodiment illustrated in FIG. 2, the lubricant used has a known emission peak between 656 nm and 658 nm (other lubricants may have emission peaks at other wavelengths). Detection of an emission peak at the known wavelength for the lubricant indicates that the lubricant is present on the surface of the workpiece. If the lubricant has characteristic emission peaks at more than one wavelength, then any of the wavelengths may be used to confirm the presence of the lubricant.

FIG. 2 includes a compilation of 12 emission spectra for treating workpieces coated with a variety of amounts of lubricant, including no lubricant. As indicated in FIG. 2, two of the spectra do not have a peak in the 656 nm to 658 nm wavelength range. This indicates that there was no lubricant present on these two workpieces. As described previously, FIG. 2 also indicates that the plasma ignited for these two workpieces because the intensity of the emission spectra is greater than zero (background).

FIG. 2 also provides an indication that the intensity of the peak at the characteristic wavelength may vary with the amount (volume) of lubricant present on the surface of the workpiece. The intensities at any one characteristic wavelength for a variety of lubricant amounts may be, but are not necessarily, linear or even proportional. Thus, it may be difficult to use the intensity at one characteristic wavelength as determinative of the amount of lubricant present on the workpiece for quality control purposes.

As described previously, lubricants may have more than one characteristic emission peak. In general terms, the lubricant may have an emission peak at a high characteristic wavelength and an emission peak at a low characteristic wavelength. The method of the present application uses a ratio of the intensity at the high characteristic wavelength to the intensity at the low characteristic wavelength to develop a more linear relationship that may be used for quality control purposes to estimate the amount of lubricant present on the workpiece 12. In one embodiment, the high characteristic wavelength may be in the range from about 550 nm to about 900 nm. In one embodiment, the low characteristic wavelength may be in the range from about 250 nm to about 550 nm.

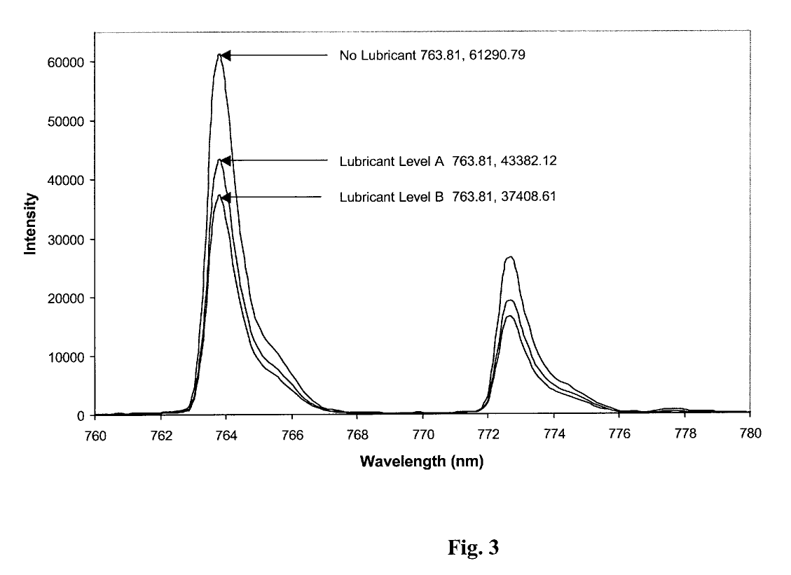

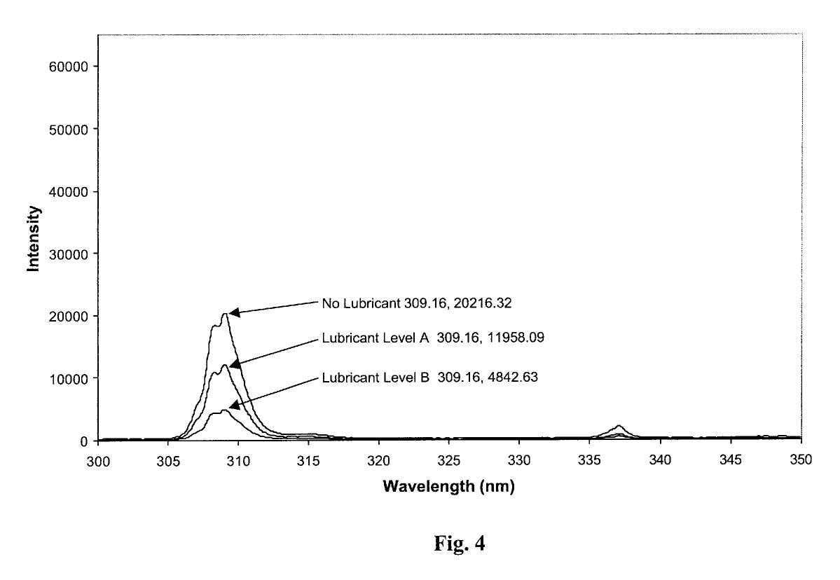

For one embodiment, FIG. 3 illustrates a close-up view of the emission spectra produced for a specific lubricant having a known characteristic wavelength of 763.81 nm. FIG. 3 illustrates the emission spectra for three amounts of lubricant: Level A, Level B (greater than Level A), and no lubricant. FIG. 4 illustrates a close-up of the same three spectra at a lower wavelength to illustrate a second characteristic wavelength at 309.16 nm.

The following table summarizes the peak intensities for the three amounts of lubricants at the high characteristic wavelength and the low characteristic wavelength. The ratio of the intensities indicates a more linear relationship. These values may be stored in the memory 18 of the second controller 17. As an emission spectrum is generated for each workpiece 12, the second controller 17 may calculate the ratio of the intensities at the characteristic emission peaks and compare the calculated value to the values stored in the memory 18. Based on the comparison, the workpiece 12 may be accepted if the ratio is at or above a predetermined target value. For example, using the data in the table below, a desired minimum amount of lubricant on the surface 13 of the workpiece 12 may correspond to a ratio of 7.72. A first workpiece 12 is treated and the ratio is calculated to be 3.50. The calculated ratio indicates that only about half (assuming a near linear relationship) of the minimum amount of lubricant was applied to the surface 13 of the workpiece 12, and the workpiece may be rejected. A second workpiece 12 is then treated and the ratio is calculated to be 7.65. The calculated ratio indicates that approximately the minimum amount of lubricant is present on the surface 13 of the workpiece 12, and the workpiece 12 may be accepted.

| | Intensity at High | Intensity at Low | |
|---|---|---|---|
| Amount | Wavelength | Wavelength | Ratio of |
| of Lubricant | (763.81 nm) | (309.16 nm) | High to Low |
| No Lubricant | 61290.79 | 20216.32 | 3.03 |
| Level A | 43382.12 | 11958.09 | 3.63 |
| Level B | 37408.61 | 4842.63 | 7.72 |

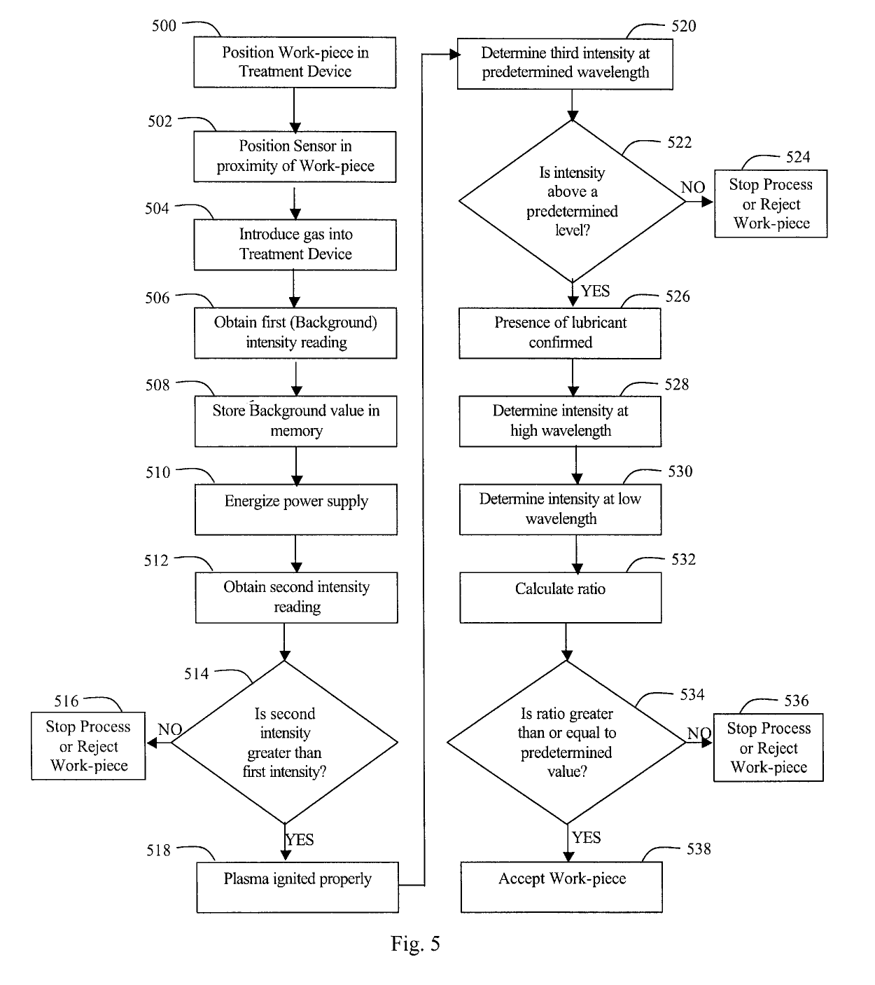

FIG. 5 illustrates a process diagram for one embodiment of the quality control method of the present application. To begin the treatment process, the workpiece 12 is placed in the outer electrode 11 of the treatment apparatus (500). A sensor 14 is then positioned in proximity to the workpiece 12 (502). In one embodiment, the sensor 14 is operative to sense an emitted spectrum and transmit a signal through the connector 15 to the analyzing device 16. In one embodiment, the sensor 14 and the connector 15 comprise a fiber optic cable that transmits the emitted spectrum to the analyzing device 16. The carrier gas and/or the reactive gas is introduced into the treatment apparatus (504).

The analyzing device 16 receives a signal from the sensor 14 prior to beginning the treatment process and determines the intensity of the background emission spectrum sensed by the sensor 14 (506). The intensity background emission spectrum in one embodiment is measured across a range of wavelengths. In one embodiment, the background intensity is measured at one or more predetermined wavelengths. The background intensity value is stored in memory 18 (508).

The first controller 20 energizes the power supply 25 (510). After the power supply 25 is energized, the analyzing device 16 determines a second intensity of the emission spectrum sensed by the sensor 14 (512). The second controller 17 compares the second intensity to the background intensity value stored in memory 18 (514). If the second intensity is greater than the background intensity by at least a predetermined amount, then the second controller 17 determines that the plasma ignited properly (518). If the second intensity is less than or equal to the background intensity value, then the second controller 17 determines that the plasma did not ignite properly and the workpiece 12 may be rejected and/or the process may be stopped (516).

The analyzing device 16 then receives a signal from the sensor 14 and determines a third intensity of the emitted spectrum at one or more predetermined wavelengths (520). The second controller 17 compares the third intensity at the predetermined wavelength to a predetermined value (522). The predetermined value may be stored in memory 18 and represents the intensity of the emission spectrum when the plasma is ignited but no lubricant is present. If the third intensity is greater than the predetermined value, then the second controller 17 confirms the presence of the lubricant on the workpiece 12 (526). If the third intensity is less than the predetermined amount, then the second controller 17 may reject the workpiece 12 and/or may stop the process (524).

The analyzing device 16 continues to analyze the signal from the sensor 14, and determines the intensity of the emission spectrum at a predetermined high wavelength (528) and a predetermined low wavelength (530). The second controller 17 calculates the ratio of the intensity at the high wavelength to the intensity at the low wavelength (532). If the ratio is greater than or equal to a predetermined value (534), then the second controller 17 determines that the intended amount of lubricant was applied to the workpiece 12, and the workpiece 12 is accepted (538). If the ratio is less than the predetermined value, then the second controller 17 may reject the workpiece 12 and/or may stop the process. The method may then be repeated for one or more additional workpieces 12.

The outer electrode 11 may include a passage (not shown) from an outer surface to the workpiece 12 to an inner chamber in which the workpiece 12 has been placed for treatment. In one embodiment, the sensor 14 may be positioned in proximity to the workpiece 12 by inserting the sensor 14 into the passage. One embodiment may include more than one sensor 14, each positioned within a passage. The sensors 14 may be located at a variety of radial positions around the workpiece 12, as well as a variety of positions along a longitudinal axis of the workpiece 12. For embodiments where more than one sensor 14 is used, the second controller 17 may utilize the emission spectra from all of the sensors 14, a portion of the sensors 14, or one of the sensors 14 in the performance of the methods illustrated in FIG. 5. The second controller 17 need not use the same sensors 14 for each workpiece 12 treated. For example, the same outer electrode 11 may be used for workpieces 12 of different lengths. Shorter workpieces 12 may not reach to sensors 14 located near a lower portion of the outer electrode 11. Thus, the second controller 17 may be programmed to ignore sensors 14 positioned in the lower portion of the outer electrode 11 for shorter workpieces 12.

In addition to quality control, embodiments of the present application may also be used for process control. For example, during a production run, the ratio may be determined for each workpiece 12 processed. Over time, the ratio data may indicate that the amount of lubricant applied has been steadily decreasing. The process may then be adjusted based on this data to maintain the process within acceptable parameters.

The methods of the present application are not limited to determining a ratio between the intensity at a single high wavelength value and the intensity at a single low wavelength value. The second controller 17 may determine the intensity at a plurality of wavelengths and calculate more than one ratio. Quality control decisions of the methods disclosed may be based on more than one ratio and may involve calculations based on multiple ratios. In addition, calculations other than ratios may be performed.

One embodiment of the present application is applicable to a lubricant treatment process utilizing an ionizing gas plasma at about atmospheric pressure. An ionizing gas plasma at about atmospheric pressure is a plasma that is generated without the use of a vacuum pump or vacuum chamber. The treatment apparatus is essentially open to the surrounding atmosphere, and the plasma is generated at conditions essentially the same as the surrounding atmosphere. However, one skilled in the art will readily appreciate that the methods of the present application are equally applicable to plasma processes performed at any pressure.

One embodiment of the present application may be used with a plasma generated in a mixture of argon and helium gases. One skilled in the art will readily appreciate that embodiments of the present application are applicable to plasmas generated in a variety of gases. Example gases suitable for generating plasmas for use with the present application include, either individually or in combination, air, oxygen, nitrogen, helium, neon, argon, krypton, and radon.

The present application is applicable for a variety of lubricants treated with an ionizing plasma. While there are generally no limitations on the lubricant that may be used with the present application, exemplary lubricants include fluorochemical compounds, perfluoropolyether compounds, functionalized perfluoropolyether compounds, and polysiloxane-based compounds.

Spatially relative terms such as “under”, “below”, “lower”, “over”, “upper”, and the like, are used for ease of description to explain the positioning of one element relative to a second element. These terms are intended to encompass different orientations of the device in addition to different orientations than those depicted in the figures. Further, terms such as “first”, “second”, and the like, are also used to describe various elements, regions, sections, etc. and are also not intended to be limiting. Like terms refer to like elements throughout the description.

As used herein, the terms “having”, “containing”, “including”, “comprising”, and the like are open ended terms that indicate the presence of stated elements or features, but do not preclude additional elements or features. The articles “a”, “an” and “the” are intended to include the plural as well as the singular, unless the context clearly indicates otherwise.

The present invention may be carried out in other specific ways than those herein set forth without departing from the scope and essential characteristics of the invention. The present embodiments are, therefore, to be considered in all respects as illustrative and not restrictive, and all changes coming within the meaning and equivalency range of the appended claims are intended to be embraced therein.

What is claimed is:

1. A method for performing quality control of a process to treat a surface of a workpiece, comprising:
generating an ionizing plasma in a gas adjacent to the surface;
determining an intensity at a first wavelength and an intensity at a second wavelength of a spectrum emitted by the ionizing plasma;
calculating a ratio of the intensity at the first wavelength to the intensity at the second wavelength; and
determining an amount of a lubricant on the surface based on the ratio.

2. The method of claim 1, wherein determining the intensity at the first wavelength and the second wavelength comprises determining the intensity at the first wavelength and at the second wavelength lower than the first wavelength.

3. The method of claim 1, wherein determining the intensity at the first wavelength and the second wavelength comprises determining the intensity the first wavelength and the second wavelength within a visible emission spectrum.

4. The method of claim 1, further comprising accepting the workpiece if the amount of the lubricant on the surface exceeds a predetermined value.

5. The method of claim 1, further comprising determining ignition of the plasma by determining an increase in intensity of a visible emitted spectrum when a power supply is energized, the power supply operative to generate the plasma.

6. A method of performing quality control of a process to treat a surface of a workpiece, comprising:
positioning a sensor adjacent to the workpiece during the treatment process, the sensor capable of sensing an emitted spectrum;
monitoring a signal from the sensor using an analyzing device, the analyzing device operative to output data based on the signal;
analyzing the data and determining an increase in the intensity of the emitted spectrum when the treatment process is initiated, and accepting the workpiece if the increase is above a first predetermined amount;
analyzing the data and determining a second increase in an intensity of the emitted spectrum at a first wavelength, and accepting the workpiece if the increase in intensity at the first predetermined wavelength exceeds a second predetermined amount;
analyzing the data and determining the intensity of the emitted spectrum at a second wavelength and at a third wavelength, and calculating a ratio of the intensity at the second wavelength to the intensity at the third wavelength, wherein the second wavelength is greater than the third wavelength;
comparing the ratio to a predetermined range and accepting the workpiece if the ratio is within the predetermined range.

7. The method of claim 6, wherein positioning the sensor adjacent to the workpiece comprises positioning at least two sensors about the workpiece.

8. The method of claim 6, wherein positioning the sensor adjacent to the workpiece includes positioning a fiber optic cable between the workpiece and the analyzing device, the fiber optic cable operative to transmit the emitted spectrum to the analyzing device.

9. The method of claim 8, wherein transmitting the emitted spectrum to the analyzing device includes transmitting the emitted spectrum to a spectrophotometer, the spectrophotometer operative to determine an intensity of the emitted spectrum at a variety of wavelengths.

10. The method of claim 6, wherein determining the increase in intensity of the emitted spectrum when the treatment process is initiated comprises determining the increase over a baseline level when a power supply operative to ignite a plasma in a gas in proximity to the surface is energized.

11. The method of claim 6, further comprising determining an amount of lubricant applied to the surface based on the ratio.

12. The method of claim 6, wherein determining the intensity at the second wavelength comprises determining the intensity at a wavelength within a range of about 550 nm to about 900 nm.

13. The method of claim 6, wherein determining the intensity at the third wavelength comprises determining the intensity at a wavelength within a range of about 250 nm to about 550 nm.

14. The method of claim 6, wherein determining the intensity comprises determining the presence of characteristic emission peaks at one or more predetermined wavelengths and measuring the intensity of the characteristic emission peaks at the one or more predetermined wavelengths.

15. The method of claim 6, wherein determining the intensity of the emitted spectrum comprises determining the intensity of a visible spectrum.

16. The method of claim 6, wherein determining the intensity of the emitted spectrum comprises determining the intensity of an infrared spectrum.

17. The method of claim 6, wherein determining the intensity of the emitted spectrum comprises determining the intensity of an ultraviolet spectrum.

18. A method of performing quality control of a process to treat a surface of a workpiece, comprising:
exposing the surface to an ionizing gas plasma at about atmospheric pressure;
determining the intensity of the spectrum emitted by the plasma at a plurality of wavelengths while the surface is exposed to the plasma;
performing a calculation based on the intensity of the emitted spectrum at least two wavelengths; and
accepting the workpiece if a result of the calculation is within a predetermined range.

19. The method of claim 18, wherein determining the intensity of the spectrum comprises determining the intensity of the visible spectrum.

20. The method of claim 18, wherein performing the calculation comprises calculating a ratio of the intensity of the spectrum at a first wavelength to the intensity of the spectrum at a second wavelength, the first wavelength greater than the second wavelength.
